(19) United States
(12) Patent Application Publication
(10) Pub. No.: US 2026/0326792 A1
(43) Pub. Date: Oct. 22, 2026

(54) THERMAL STATE-BASED AUTONOMOUS VEHICLE DEPLOYMENT

(71) Applicant: GM GLOBAL TECHNOLOGY OPERATIONS LLC, DETROIT, MI (US)

(72) Inventors: Shawn McGrady, Holly, MI (US); Aaron B. Bloom, Royal Oak, MI (US); Susan A. Dombrowski, Milford, MI (US)

(21) Appl. No.: 19/180,297

(22) Filed: Apr. 16, 2025

(51) Int. Cl. B60W 60/00; G06Q 50/47; G07C 5/08

(52) U.S. Cl. CPC B60W 60/00253; G06Q 50/47; G07C 5/0841; B60W 2510/242; B60W 2510/30; B60W 2555/20

(57) ABSTRACT

Examples described herein provide a method that includes receiving a ride request from a user device associated with a user. The method further includes determining suitable vehicles based on the ride request. The method further includes collecting and storing vehicle data from the suitable vehicles, the vehicle data indicating thermal information about the suitable vehicles. The method further includes generating a thermal ranking of the suitable vehicles based on the vehicle data. The method further includes generating a route plan based on the thermal ranking. The method further includes autonomously deploying one of the suitable vehicles based on the thermal ranking and the route plan.

### BACKGROUND

The subject disclosure relates to vehicles, and in particular to thermal state-based unsupervised autonomous and semi-supervised autonomous vehicle operation vehicle deployment.

Autonomous vehicles are self-driving cars equipped with advanced sensors and processing systems that enable them to navigate and operate without human intervention or with advanced driver assistance systems that may allow for semi-supervised human intervention. In some cases, a fleet of autonomous vehicles may provide rides to users upon request. For example, a fleet of self-driving vehicles that are strategically positioned throughout a service area stand ready to respond to ride requests from users. When a user requests transportation, the user can use a mobile application or other digital interface to request a ride. A system then evaluates the available vehicles in the fleet, considering various criteria, such as the proximity of each vehicle to the user's location, a desired destination of travel for the user, and each vehicle's current state of charge. This evaluation ensures that a suitable vehicle is selected to provide the service, optimizing for factors like energy efficiency, passenger comfort, and timely arrival. The selected autonomous vehicle then navigates to the user's location autonomously, providing a seamless and efficient transportation experience. This model not only enhances convenience for users but also maximizes the operational efficiency of the vehicle fleet, reducing wait times and improving resource utilization.

The desire for improving autonomous vehicle deployment remains.

### SUMMARY

In one embodiment, a computer-implemented method is provided. The method includes receiving a ride request from a user device associated with a user. The method further includes determining suitable vehicles based on the ride request. The method further includes collecting and storing vehicle data from the suitable vehicles, the vehicle data indicating thermal information about the suitable vehicles. The method further includes generating a thermal ranking of the suitable vehicles based on the vehicle data. The method further includes generating a route plan based on the thermal ranking. The method further includes autonomously deploying one of the suitable vehicles based on the thermal ranking and the route plan.

In addition to one or more of the features described herein, or as an alternative, further embodiments of the method may include that the vehicle data includes at least one selected from a group consisting of environmental data, cabin thermal state of health data, rechargeable energy storage system state of health data, thermal system state of health data, compute state of health data, and sensor suite state of health data.

In addition to one or more of the features described herein, or as an alternative, further embodiments of the method may include that the vehicle data includes environmental data, cabin thermal state of health data, rechargeable energy storage system state of health data, thermal system state of health data, compute state of health data, and sensor suite state of health data.

In addition to one or more of the features described herein, or as an alternative, further embodiments of the method may include that the one of the suitable vehicles that is deployed is selected based on an overall thermal status rank.

In addition to one or more of the features described herein, or as an alternative, further embodiments of the method may include that the overall thermal status rank is determined based on environmental conditions, cabin conditions, rechargeable energy storage system state of health, compute state of health, a thermal system state of health, and forecasts.

In addition to one or more of the features described herein, or as an alternative, further embodiments of the method may include that the environmental conditions include an initial outside air temperature, a corrected outside air temperature, and a solar load.

In addition to one or more of the features described herein, or as an alternative, further embodiments of the method may include that the cabin conditions include an initial cabin air temperature, a filtered cabin air temperature, a user desired cabin temperature, and a change in desired cabin temperature relative to a current raw temperature.

In addition to one or more of the features described herein, or as an alternative, further embodiments of the method may include that the rechargeable energy storage system state of health includes a high voltage cooling priority request, a rechargeable energy storage system cell temperature, and a rechargeable energy storage system state of health value.

In addition to one or more of the features described herein, or as an alternative, further embodiments of the method may include that the compute state of health includes an autonomous vehicle cooling priority request, a maximum central processing unit temperature, a maximum graphics processing unit temperature, a maximum motherboard temperature, and a maximum memory temperature.

In addition to one or more of the features described herein, or as an alternative, further embodiments of the method may include that the thermal system state of health includes a chiller power request, an evaporator power request, a cooling power residual capacity, and a chiller power versus evaporator power ratio.

In addition to one or more of the features described herein, or as an alternative, further embodiments of the method may include that the forecasts include a forecasted time to achieve cabin comfort, a forecasted rechargeable energy storage system idle time remaining, and a forecasted city range.

In addition to one or more of the features described herein, or as an alternative, further embodiments of the method may include that autonomously deploying the one of the suitable vehicles includes causing the one of the suitable vehicles to follow the route plan to a location indicated by the ride request.

In another embodiment, an autonomous vehicle deployment system is provided. The autonomous vehicle deployment system includes a user device that generates a ride request, a plurality of autonomous vehicles, and a processing system. The processing system includes a memory having computer readable instructions and a processing device for executing the computer readable instructions, the computer readable instructions controlling the processing system to perform operations for thermal state-based autonomous vehicle deployment. The operations include receiving the ride request from the user device associated with a user. The operations further include determining suitable vehicles based on the ride request. The operations further include collecting and storing vehicle data from the suitable vehicles, the vehicle data indicating thermal information about the suitable vehicles, user data, and user preferences. The operations further include generating a thermal ranking of the suitable vehicles based on the vehicle data. The operations further include generating a route plan based on the thermal ranking. The operations further include autonomously deploying one of the suitable vehicles based on the thermal ranking and the route plan.

In addition to one or more of the features described herein, or as an alternative, further embodiments of the autonomous vehicle deployment system may include that the vehicle data includes at least one selected from a group consisting of environmental data, cabin thermal state of health data, rechargeable energy storage system state of health data, thermal system state of health data, compute state of health data, and sensor suite state of health data.

In addition to one or more of the features described herein, or as an alternative, further embodiments of the autonomous vehicle deployment system may include that the vehicle data includes environmental data, cabin thermal state of health data, rechargeable energy storage system state of health data, thermal system state of health data, compute state of health data, and sensor suite state of health data.

In addition to one or more of the features described herein, or as an alternative, further embodiments of the autonomous vehicle deployment system may include that the one of the suitable vehicles that is deployed is selected based on an overall thermal status rank.

In addition to one or more of the features described herein, or as an alternative, further embodiments of the autonomous vehicle deployment system may include that the overall thermal status rank is determined based on environmental conditions, cabin conditions, rechargeable energy storage system state of health, compute state of health, thermal system state of health, and forecasts.

In another embodiment a computer program product is provided. The computer program product includes a set of one or more computer-readable storage media and program instructions, collectively stored in the set of one or more computer-readable storage media, for causing a processor set to perform computer operations for thermal state-based autonomous vehicle deployment. The operations include receiving a ride request from a user device associated with a user. The operations further include determining suitable vehicles based on the ride request. The operations further include collecting and storing vehicle data from the suitable vehicles, the vehicle data indicating thermal information about the suitable vehicles. The operations further include generating a thermal ranking of the suitable vehicles based on the vehicle data. The operations further include generating a route plan based on the thermal ranking. The operations further include autonomously deploying one of the suitable vehicles based on the thermal ranking and the route plan.

In addition to one or more of the features described herein, or as an alternative, further embodiments of the computer program product may include that the one of the suitable vehicles that is deployed is selected based on an overall thermal status rank.

In addition to one or more of the features described herein, or as an alternative, further embodiments of the computer program product may include that the overall thermal status rank is determined based on environmental conditions, cabin conditions, rechargeable energy storage system state of health, compute state of health, thermal system state of health, and forecasts, wherein the environmental conditions include an initial outside air temperature, a corrected outside air temperature, and a solar load, wherein the cabin conditions include an initial cabin air temperature, a filtered cabin air temperature, a user desired cabin temperature, and a change in desired cabin temperature relative to a current raw temperature, wherein the rechargeable energy storage system state of health includes a high voltage cooling priority request, a rechargeable energy storage system cell temperature, and a rechargeable energy storage system state of health value, wherein the compute state of health includes an autonomous vehicle cooling priority request, a maximum central processing unit temperature, a maximum graphics processing unit temperature, a maximum motherboard temperature, and a maximum memory temperature, wherein the thermal system state of health includes a chiller power request, an evaporator power request, a cooling power residual capacity, and a chiller power versus evaporator power ratio, and wherein the forecasts include a forecasted time to achieve cabin comfort, a forecasted rechargeable energy storage system idle time remaining, and a forecasted city range.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates vehicles in communication with a processing system for thermal state-based autonomous vehicle deployment according to one or more embodiments;

FIG. 2 illustrates a method for thermal state-based autonomous vehicle deployment according to one or more embodiments;

FIG. 3A-3F illustrate tables for thermal state-based autonomous vehicle deployment according to one or more embodiments; and

FIG. 4 illustrates a block diagram of a processing system for thermal state-based autonomous vehicle deployment according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to thermal state-based autonomous vehicle deployment.

In recent years, the development of autonomous vehicles has advanced significantly, with a focus on improving safety, efficiency, and user experience. However, one of the persistent challenges in the deployment of autonomous vehicles is managing the thermal state of the vehicle systems, which can significantly impact vehicle performance and passenger comfort. Effective thermal management of autonomous vehicles is important, as it affects the vehicle's energy consumption, the longevity of the vehicle's components, and the overall user experience. Existing approaches to autonomous vehicle deployment often rely on basic parameters, such as vehicle proximity to the user and the state of charge (SOC) of the vehicle's battery. These approaches do not adequately account for the complex thermal dynamics that can influence vehicle performance and passenger comfort. For example, such approaches often overlook the intricate thermal interactions within the vehicle, such as the impact of environmental conditions, cabin temperature, and the thermal state of components (e.g., batteries and computing systems). As a result, these existing approaches may lead to suboptimal vehicle deployment decisions, resulting in increased energy consumption, reduced component lifespan, and compromised passenger comfort. Furthermore, existing solutions may not effectively balance the thermal needs of the vehicle with the demands of the passenger, leading to inefficient energy use and potential user dissatisfaction.

One or more embodiments described herein address these and other shortcomings by introducing a comprehensive approach for thermal state-based autonomous vehicle deployment. According to one or more embodiments, a holistic strategy is implemented for evaluating the thermal status of autonomous vehicles, considering a wide range of inputs, including environmental conditions, cabin conditions, and the thermal state of health of various vehicle systems. By generating a thermal ranking of suitable vehicles for deployment, one or more embodiments optimizes vehicle deployment decisions to enhance energy efficiency, improve passenger comfort, and maximize ride-share revenue. Such approaches leverage advanced algorithms to forecast the thermal capacity of each vehicle, ensuring that the most suitable vehicle is deployed for each ride request in most cases. As a result, the operational efficiency of autonomous vehicles is improved while also enhancing the overall user experience by considering thermal comfort and energy conservation.

According to one or more embodiments, the overall vehicle state-of-health (SOH) along with current status of the cabin, proximity and route to user, user's desired temperature setting, and time to cool cabin down are all weighted to select an autonomous vehicle to deploy in response to a ride request. The vehicles may be rank ordered based on the thermal capability, user usage, and the route path planner. As used herein, the phrase “time to pull cabin down” refers to the duration of time to adjust the cabin temperature of a vehicle to a desired level (e.g., the user's desired temperature setting), typically cooling it down to ensure passenger comfort. This involves the vehicle's climate control system operating to lower (or raise) the cabin temperature from its current state to the temperature set by the user or system, raising or lowering the temperature of the rechargeable energy storage system (RESS) and propulsion system to minimize the risk of de-rating components, and/or the like, including combinations and/or multiples thereof.

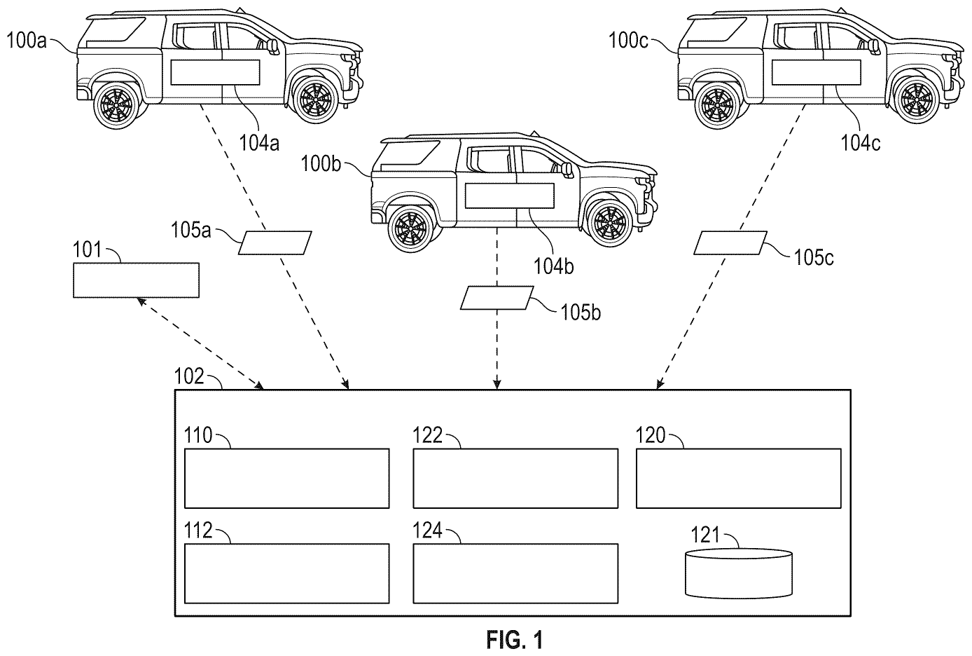

FIG. 1 shows vehicles 100 and a user device 101 connected to a processing system 102 for thermal state-based autonomous vehicle deployment according to one or more embodiments. For example, in this figure, three vehicles are shown: vehicle 100a, vehicle 100b, and vehicle 100c, which are collectively referred to as “vehicles 100.”

The vehicles 100 can be a car, a truck, a van, a bus, a motorcycle, a boat, or any other type of automobile, including various combinations thereof. The vehicles 100 can be liquid fuel powered vehicles powered by liquid fuel (e.g., gasoline, diesel fuel, liquid natural gas, etc.), electric vehicles powered by electrical power, and/or hybrid electric vehicles (e.g., a plug-in hybrid electric vehicle (PHEV) partially or wholly powered by electrical power). According to one or more embodiments, the vehicles 100 can include various components (not shown), such as an electric motor, a rechargeable energy storage system, an internal combustion engine, and/or the like, including combinations and/or multiples thereof, that provide electrical and/or mechanical energy for providing propulsion to the vehicles 100. According to one or more embodiments, the vehicles 100 are autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The vehicles 100 include sensors 104. For example, in this figure, each of the vehicles 100a-100c, includes sensors 104a, 104b, 104c, respectively, which are collectively referred to as “sensors 104.” The sensors 104 represent one or more sensors, which may vary in type. The sensors 104 may be any suitable sensor(s) and/or combination of sensors, such as a camera, a radar device (also referred to as a “radar sensor”), a lidar device (also referred to as a “lidar sensor”), a proximity sensor, temperature sensor, pressure sensor, and/or the like, including combinations and/or multiples thereof. The arrows between the sensors 104 and the processing system 102 indicate the flow of data (e.g., data 105 of FIG. 1) from the sensors 104 to the processing system 102, highlighting the interaction between these components. For example, sensors 104a of the vehicle 100a collect data 105a, sensors 104b of the vehicle 100b collect data 105b, and sensors 104c of the vehicle 100c collect data 105c, the data 105a-105c collectively referred to as “data 105.”

The user device 101 is a digital interface, such as a smartphone, tablet, or other computing device, that allows users to interact with the autonomous vehicle deployment system. Through the user device 101, a user can request rides, provide user data (e.g., location, payment information, etc.), specify his or her user preferences (e.g., thermostat settings, vehicle type, number of passengers, etc.), and receive updates about ride status. The user device 101 communicates with the processing system 102 to transmit ride requests and receive information about the selected vehicle from the fleet of vehicles, ensuring a seamless and efficient user experience.

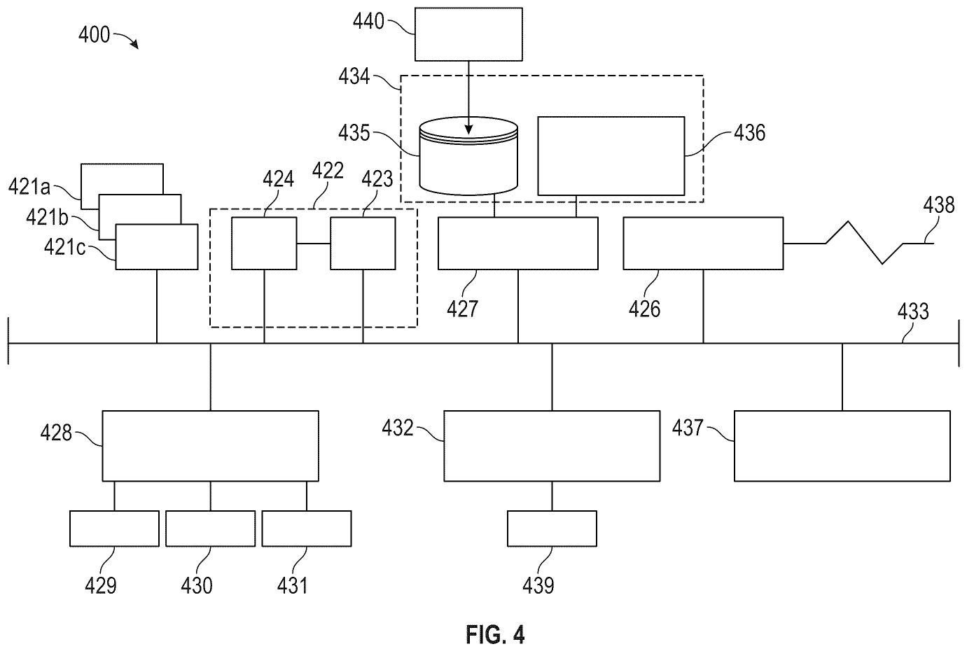

The processing system 102 is responsible for managing the overall operation of the autonomous vehicle deployment process, including executing instructions, processing data, and coordinating the interaction between the user device 101, the fleet of vehicles (e.g., the vehicles 100), and the various engines that evaluate and rank the vehicles based on thermal and operational criteria as further described herein. According to one or more embodiments, the processing system 102 is referred to as a “back office system” that may be responsible for deploying the vehicles 100 to riders and/or ranking vehicles to choose a suitable vehicle. According to one or more embodiments, the processing system 102 includes a processing device 110, a memory 112, a data collection engine 120, a thermal evaluation engine 122, and a deployment engine 124. It should be appreciated that the processing system 102 can be any device suitable for thermal state-based autonomous vehicle deployment to deploy one or more of the vehicles 100 responsive to a ride request from the user device 101. For example, the processing system 102 can be a smartphone, tablet computer, laptop computer, desktop computer, wearable computing device, server, cloud computing system, and/or the like, including combinations and/or multiples thereof. As yet another example, the processing system 102 can be the processing system 400 of FIG. 4 and/or can include one or more components of the processing system 400 of FIG. 4.

The processing device 110 is responsible for executing instructions and managing the overall operation of the processing system 102. The processing device 110 can be any suitable processing circuitry for executing instructions and processing data. For example, the processing device 110 can be a microcontroller, microprocessor, application-specific integrated circuit (ASIC), or any other type of processing unit capable of handling the computational demands of the processing system 102. The processing device 110 is an example of one or more of the processing devices 421 of FIG. 4, as described in more detail herein.

The memory 112 stores data (e.g., data 105), computer-readable instructions, and algorithms useful for operation of the processing system 102. This may include real-time data processing, historical data analysis, and storage of firmware or software programs. The memory 112 is any suitable device for storing data, such as the data 105 received from the sensors 104, and/or instructions. For example, the memory 112 can be a combination of volatile memory (e.g., random access memory) and non-volatile memory (e.g., read-only memory, flash memory). The memory 112 is an example of one or more of the system memory 422, the random access memory 423, and/or the read-only memory 424 of FIG. 4, as described in more detail herein.

The data collection engine 120 is responsible for gathering and storing a wide array of vehicle data (e.g., data 105) used for optimizing autonomous vehicle deployment. The data collection engine 120 collects information from various sensors (e.g., sensors 104) embedded within the vehicle, including data on environmental conditions, cabin thermal state, and the state of health of vehicle systems such as the RESS and computing components. The data collection engine 120 can store the collected data (e.g., data 105) in a database 121, which can be any suitable repository for storing data. By aggregating data 105, the data collection engine 120 provides a comprehensive view of the current thermal status and operational readiness for each of the vehicles 100. This information is then used to generate a thermal ranking of the vehicles, which aids in selecting a suitable vehicle for deployment in response to a ride request. The data collection engine 120 plays a role in ensuring that the deployment decisions are informed by real-time, accurate data, thereby enhancing energy efficiency and passenger comfort.

The thermal evaluation engine 122 is responsible for analyzing the vehicle data (e.g., data 105) collected from the vehicle's sensors (e.g., sensors 104) to assess the current thermal state of the vehicles 100 and predict future thermal conditions. According to one or more embodiments, the vehicle data (e.g., data 105) can be processed in part or in whole at the vehicles 100, which may be referred to as pre-processing, before the data is transmitted to the processing system 102. The thermal evaluation engine 122 processes information related to environmental conditions, cabin temperature, thermal systems, sensors, control module data, calculated signals for thermal ranking, and the thermal state of various vehicle systems, such as the battery and computing components. By evaluating these factors, the thermal evaluation engine 122 generates a thermal ranking for each of the vehicles 100, and the thermal ranking is used to determine a suitable vehicle for deployment in response to a ride request received via the user device 101. This ranking helps optimize energy efficiency and passenger comfort by ensuring that vehicles are deployed with consideration of their thermal readiness. The thermal evaluation engine 122 can forecast the thermal capacity of each of the vehicles 100, allowing for informed decision-making that enhances the overall operational efficiency of the autonomous vehicle fleet. According to one or more embodiments, the thermal ranking can be calculated by any suitable combination of on-board computing (e.g., at one of the vehicles 100), back-office computing (e.g., at the processing system 102), cloud-based computing (e.g., at a node of a cloud computing system), and/or the like, including combinations and/or multiples thereof.

The deployment engine 124 is responsible for executing a final selection and dispatch of autonomous vehicles based on the thermal ranking and other operational criteria, such as a route plan. Once the thermal evaluation engine 122 has determined a suitable vehicle for a ride request, the deployment engine 124 coordinates the vehicle's autonomous navigation to the user's location. According to one or more embodiments, the route plan can be adjusted before picking up the user and/or after picking up the user to optimize thermal performance of the vehicle. According to one or more embodiments, the deployment engine 124 ensures that the selected vehicle follows the optimal route plan, taking into account real-time traffic conditions and any necessary adjustments to maintain passenger comfort and energy efficiency. The deployment engine 124 also manages the communication between the selected vehicle and the user device 101, providing updates on the vehicle's estimated arrival time and any changes in ride status. By overseeing the deployment process, the deployment engine 124 plays a role in delivering a seamless and efficient transportation experience, maximizing the operational effectiveness of the autonomous vehicle fleet.

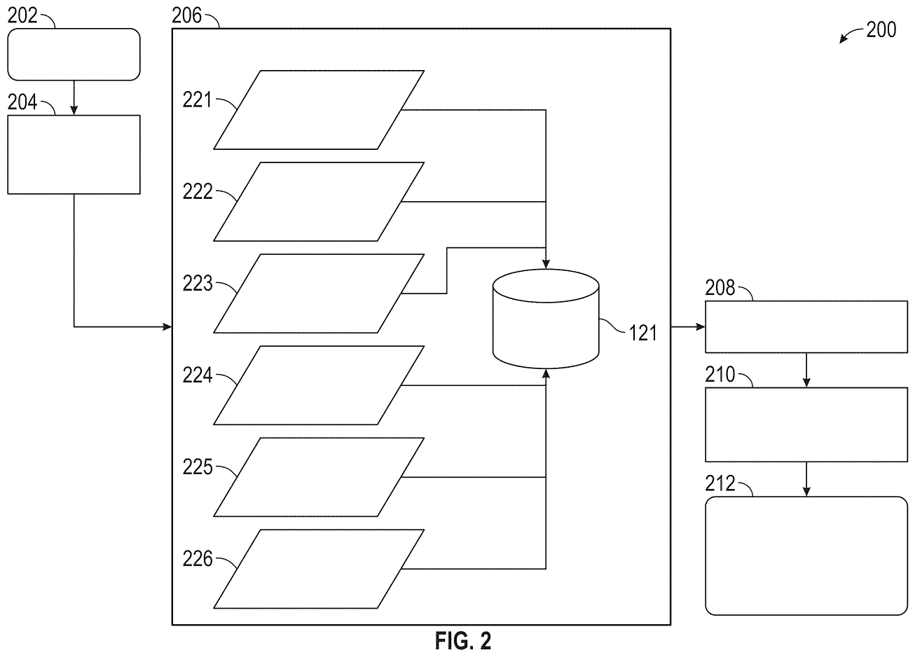

FIG. 2 illustrates a flow diagram of a method 200 for thermal state-based autonomous vehicle deployment according to one or more embodiments. The method 200 can be implemented using any suitable system or device. For example, the method 200, and its operations, can be implemented using the processing system 102 of FIG. 1, by the processing system 400 of FIG. 4, and/or the like, including combinations and/or multiples thereof. The method 200 is now described with reference to at least portions of FIG. 1 but is not so limited.

In operation 202, the method 200 begins with the receipt of a ride request from a user. The ride request is typically generated through the user device 101, such as a smartphone or tablet, which communicates with the processing system 102 (also referred to as an “autonomous vehicle deployment system”). The ride request includes information, such as the user's current location, desired destination, and any specific preferences or requirements for the ride, such as a temperature set point for the cabin of the vehicle. This initial step sets the stage for evaluating the available vehicles and determining a suitable vehicle for fulfilling the user's ride request.

Operation 204 involves generating a list of suitable vehicles that can potentially fulfill the ride request. In this operation, the processing system 102 assess the fleet of autonomous vehicles (e.g., the vehicles 100), considering factors such as proximity to the user's location, current state of charge, desired destination, and overall readiness for deployment. At operation 204, the processing system 102 identifies a subset of vehicles that are capable of providing the requested service while optimizing for efficiency and user satisfaction.

In operation 206, the processing system 102, via the data collection engine 120, collects and stores vehicle data (e.g., data 105) from the identified suitable vehicles. The data 105 encompasses a wide range of thermal and operational parameters, including environmental conditions, cabin thermal state, and the state of health of various vehicle systems. The collected data is stored in the database 121 as individual vehicle thermal ranking and forecasts, providing a comprehensive view of each vehicle's current status and readiness for deployment. This information is useful for generating a thermal ranking and making informed deployment decisions.

Examples of types of data collected at operation 206 may include, but is not limited to, environmental data 221, cabin thermal state of health data 222, RESS state of health data 223, thermal system state of health data 224, compute state of health data 225, and/or sensor suite state of health data 226.

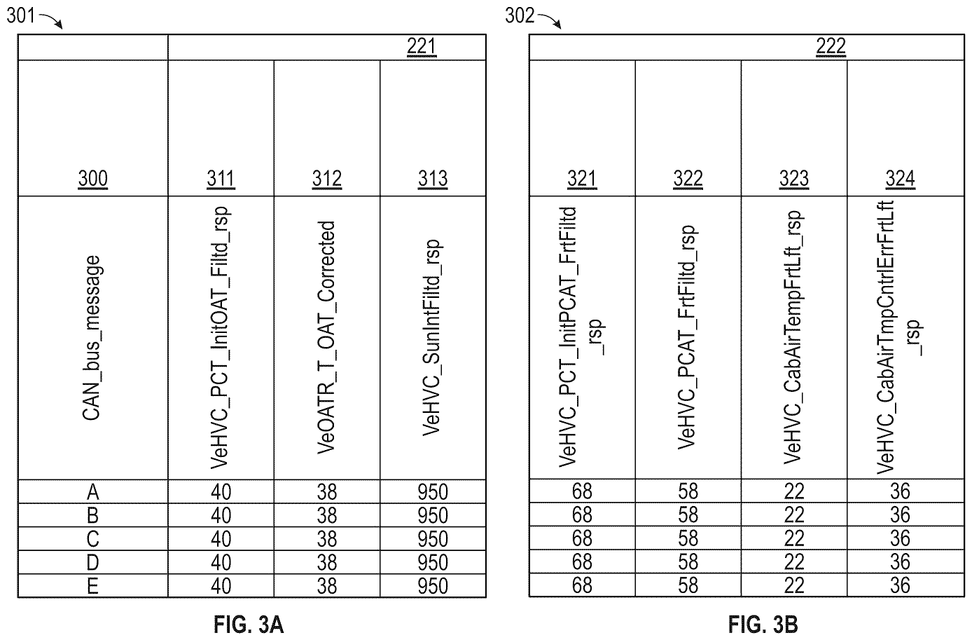

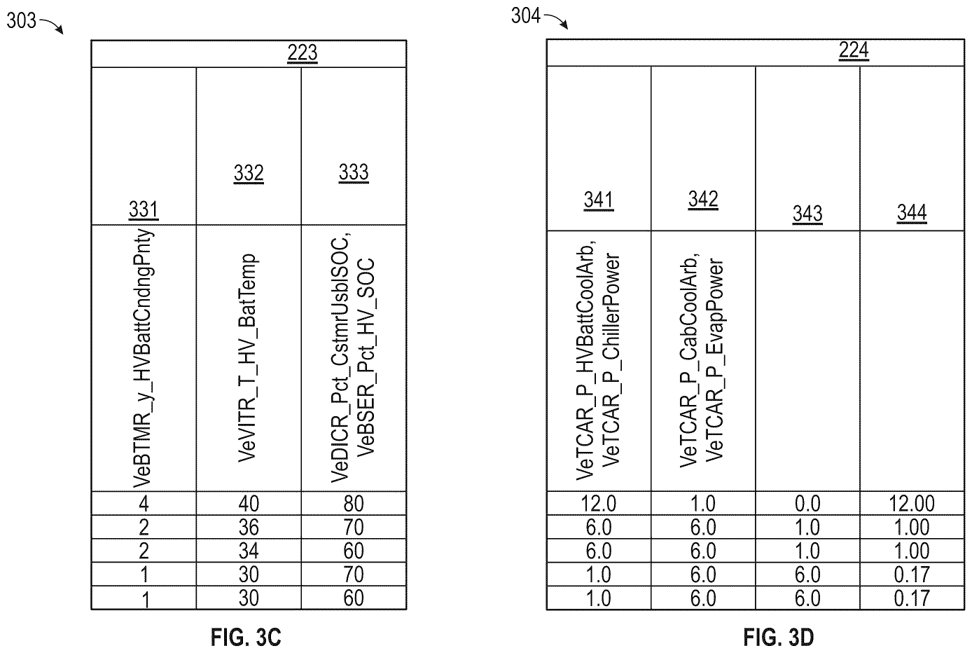

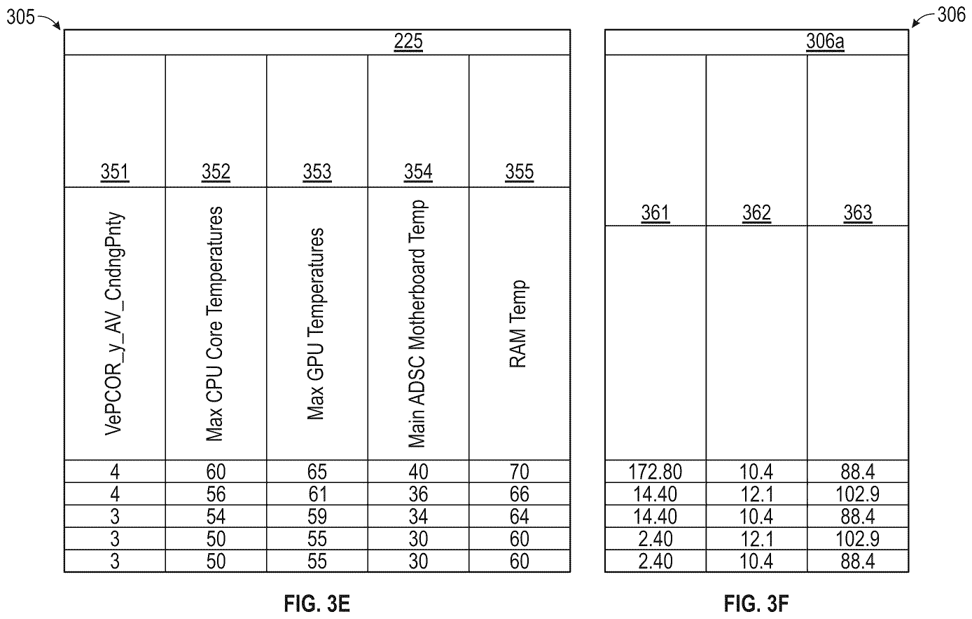

FIGS. 3A-3F depict information about the types of data that may be collected at operation 206 and are now described in more detail. In particular, FIG. 3A-3F illustrates tables 301-306, respectively, for thermal state-based autonomous vehicle deployment according to one or more embodiments. The tables 301-306 depict values considered during a ranking process described herein with reference to operation 208 for five hypothetical vehicles 300, labeled A, B, C, D, E in table 301 and continuing through tables 302-306.

Environmental data 221 may include initial outside air temperature 311, corrected outside air temperature 312, and solar load 313 (table 301 of FIG. 3A). Initial outside air temperature 311 is the outside air temperature of the vehicle, at initial wake up, that the vehicle was soaked at. Corrected outside air temperature 312 is a corrected, or filtered, outside air temperature based on vehicle speed and time. This will help determine how much energy is needed to condition the cabin of the vehicle. Solar load 313 is the sun load intensity on the vehicle as measured by an indicator light and solar sensor (ILLS) either on the top of the dash or on the top of a roof top module (RTM). This can be a weighted variable that is applied to the capacity of the vehicle based on measured testing in different conditions in the thermal chamber. High solar load has a significant impact on cooling the cabin and is therefore built into the deployment algorithm.

Cabin thermal state of health data 222 may include initial cabin air temperature 321, filtered cabin air temperature 322, user desired cabin temperature 323, and the change in desired cabin temperature to current raw temperature 324 (table 302 of FIG. 3B).

Initial cabin air temperature 321 is the vehicle interior temperature as measured by the passenger compartment air temperature (PCAT). Filtered cabin air temperature 322 is the filtered PCAT temperatures, raw value used as a reference variable for other internal and external variables. User desired cabin temperature 323 is the temperature requested by the customer, also known as the “Tset” which will be either set by the autonomous driving super computer (ADSC or received by ADSC set by the customer via back-end application on the user device 101 once the ride request is received. The desired cabin offset variable is calculated by the forecasted time to move from the current setpoint to the target value and is used as a time-based variable to precondition the vehicle. The change (or delta) from desired cabin temperature to current raw temperature 324 is a calculated value that is the difference between the Tset and filtered PCAT.

RESS state of health data 223 may include high voltage cooling priority request 331, RESS cell temperature 332, and RESS state of charge value 333 (table 303 of FIG. 3C). High voltage cooling priority request 331 is used to provide understanding of what the vehicle's climate control system's compressor and chiller are capable of providing (e.g., to enter a max cold scenario as well as the time to reach it). RESS cell temperature 332 is the maximum cell temp that is cross referenced against peak allowable pack temp to determine how much overheard heat rise there is on the RESS before the RESS will either slow down charging and/or artificially clip cabin conditioning due to cooling prioritization. The RESS may also derate current output due to high internal temperatures. If the RESS is already warm from driving or L3 charging, it may be recommended that a different action to first cool down the RESS is performed and then condition the cabin. RESS SOC value 333 is the charge of the battery that is used to understand how long the vehicle will be able to idle/drive while thermally conditioning itself. For example, the vehicle may only have a few hours of operation left if significant cooling is required and will be more efficient to charge because it will accept higher charge rate when lower SOC if the pack is cool enough.

Thermal system state of health data 224 may include chiller power request 341, evaporator power request 342, cooling power residual capacity 343, and chiller power versus evaporator power ratio 334 (table 304 of FIG. 3D). Chiller power request 341 is the amount of cooling power requested by the chiller of the vehicle. Evaporator power request 342 is the amount of cooling power requested by the evaporator of the vehicle. Cooling power residual capacity 343 is the amount of remaining cooling capacity remaining in the system. Chiller power versus evaporator power ratio 344 is a calibrated trade-off between cooling the vehicle versus cooling the passenger and is used in charging scenarios to prioritize vehicle preconditioning to prepare the vehicle for deployment or cabin conditioning to take an already cooled vehicle and focus on cabin comfort.

Compute state of health data 225 may include autonomous vehicle cooling priority request 351, maximum central processing unit (CPU) temperature 352, maximum graphics processing unit (GPU) 353 temperature, maximum motherboard temperature 354, and maximum memory temperature 355 (table 305 of FIG. 3E). Autonomous vehicle cooling priority request 351 sets a priority value for cooling. Maximum CPU temperature 352 is the maximum arbitrated CPU temperature in the autonomous driving computer of the vehicle. Maximum GPU temperature 353 is the maximum arbitrated GPU temperature in the autonomous driving computer of the vehicle. Maximum motherboard temperature 354 is the maximum arbitrated motherboard temperature in the autonomous driving computer of the vehicle. Maximum memory temperature 355 is the maximum arbitrated memory temperature in the autonomous driving computer of the vehicle. The autonomous driving computer, also referred to as an “Autonomous Driving Super Computer” (ADSC) is liquid cooled and rejects heat into the system which is interconnected to the RESS. The compute temperatures are used to understand how much capacity the ADSC is using of the whole system.

Sensor suite state of health data 226 (see FIG. 2) may include data from various sensors that monitor the operational status and environmental conditions affecting the vehicle, such as clearing ice, fog, or sensor cleaning. The data stored in the database 121 can also include forecasts 306a shown in table 306 of FIG. 3F, where the forecasts 306a can include a forecasted time to achieve cabin comfort 361, a forecasted RESS idle time remaining 362, and a forecasted city range 363. The forecasts 306a can be based on the data from the sensors 104, historical data about a particular vehicle (e.g., vehicle 100a), historical data about the fleet of vehicles (e.g., the vehicles 100), and/or the like, including combinations and/or multiples thereof.

Forecasted time to achieve cabin comfort 361 is an estimate of how long it will take to condition the cabin based on the initial PCAT and the user desired cabin temperature (Tset). This calculation can be revised once the vehicle cabin warm-up and cabin pull-down curves are established. This is a useful input to ensure that the vehicle cabin is conditioned properly prior to riders entering the vehicle. Forecasted RESS idle time remaining 362 is an instantaneous idle time that considers the RESS SOC, RESS temperature, and/or ADSC temperature along with the respective cooling priorities and vehicle parasitic loads. Forecasted city range 363 an estimated city traffic cycle the vehicle can traverse that considers the RESS SOC, RESS temperature, and/or ADSC temperature along with the respective cooling priorities and vehicle parasitic loads.

With continued reference to FIG. 2, operation 208 focuses on generating a thermal ranking of the suitable vehicles based on the collected data (e.g., the data stored in the database 121) at operation 206. The thermal evaluation engine 122 analyzes the data to assess the current thermal state of each of the vehicles 100 and predicts future thermal conditions. By considering factors such as environmental conditions, cabin temperature, and the thermal state of vehicle systems, the thermal evaluation engine 122 generates a ranking that reflects each vehicle's thermal readiness for deployment given the ride request and/or user preferences (e.g., temperature set points). This ranking helps ensure that a suitable vehicle is selected to optimize energy efficiency and passenger comfort.

According to one or more embodiments, a thermal ranking (“overall thermal status rank”) for the five hypothetical vehicles 300 (A, B, C, D, and E) is computed as follows: vehicle A has a value of 131.86, vehicle B has a value of 12.74, vehicle C has a value of 13.06, vehicle D has a value of 3.74, and vehicle E has a value of 4.06. The overall thermal status rank provides a relative ranking approach between vehicles to identify the optimal vehicle to deploy for a particular ride request. Vehicles can be clustered together to show vehicles with nearly the same overall ranking and outliers (e.g., vehicle A) that must pre-condition prior to deployment for ride hail can be identified. In this example, vehicle D is considered the optimal vehicle based on having the lowest overall thermal status rank value.

In operation 210, a route plan is generated based on the thermal ranking. The deployment engine 124 uses the ranking to determine an optimal route (or a ranked lists of routes) for the selected vehicle, taking into account real-time traffic conditions and any necessary adjustments to maintain passenger comfort and energy efficiency. The route plan ensures that the vehicle selected for deployment follows the most efficient path to the user's location, minimizing travel time and energy consumption. According to one or more embodiments, the route can be adjusted pre- and/or post-user pickup to allow for cabin to stabilize (e.g., heat or warm up) propulsion system to achieve optimal thermal state.

Finally, operation 212 involves deploying the selected vehicle based on the thermal ranking and route plan. The deployment engine 124 coordinates the selected vehicle's autonomous navigation to the user's location, to aid the selected vehicle in following the optimal route and arriving in a timely manner. The deployment engine 124 also manages communication between the selected vehicle and the user device 101, providing updates on the selected vehicle's estimated arrival time and any changes in ride status. This operation completes the method 200, delivering a seamless and efficient transportation experience for the user. By integrating thermal and operational criteria, the method 200 enhances energy efficiency, passenger comfort, and overall fleet effectiveness.

Additional processes also may be included, and it should be understood that the processes depicted in FIG. 2 represent illustrations, and that other processes may be added, or existing processes may be removed, modified, or rearranged without departing from the scope of the present disclosure. It should also be understood that the processes depicted in FIG. 2 may be implemented as programmatic instructions stored on a non-transitory computer-readable storage medium that, when executed by a processor (e.g., the processing device 110 of FIG. 1, the processor(s) 421 of FIG. 4, and/or the like, including combinations and/or multiples thereof) of a computing system (e.g., the processing system 102 of FIG. 1, the processing system 400 of FIG. 4, and/or the like, including combinations and/or multiples thereof), cause the processor to perform the processes described herein.

The technical benefits of the described embodiments include significant improvements to the functioning of vehicles by optimizing the deployment and operation of autonomous vehicles within a fleet. By incorporating a comprehensive thermal management strategy, one or more embodiments enhances energy efficiency, reduces wear on vehicle components, and improves passenger comfort. The ability to evaluate and rank suitable vehicles based on their thermal readiness ensures that the a vehicle is selected for each ride request that optimizes vehicle efficiency and passenger comfort, leading to more efficient energy use and extended component lifespan for the fleet. This approach also minimizes downtime and maximizes ride-share revenue by ensuring that vehicles are better prepared to meet the demands of each specific ride. Additionally, the integration of real-time data allows for more informed decision-making, resulting in a seamless and efficient transportation experience for users. Overall, these improvements contribute to the operational effectiveness of the AV fleet, reducing wait times and improving resource utilization.

It is understood that one or more embodiments described herein is capable of being implemented in conjunction with any other type of computing environment now known or later developed. For example, FIG. 4 depicts a block diagram of a processing system 400 for implementing the techniques described herein. In accordance with one or more embodiments described herein, the processing system 400 is an example of a cloud computing node of a cloud computing environment. In examples, processing system 400 has one or more central processing units (referred to also as “processors” or “processing resources” or “processing devices”) 421a, 421b, 421c, etc. (collectively or generically referred to as processor(s) 421 and/or as processing device(s) 421). In aspects of the present disclosure, each processor 421 can include a reduced instruction set computer (RISC) microprocessor. Processors 421 are coupled to a system memory 422 and/or various other components via a system bus 433. The system memory 422 can include one or more temporary and/or persistent memory devices, such as a random access memory (RAM) 423, a read-only memory (ROM) 424, and/or the like, including combinations and/or multiples thereof. The system bus 433 may include a basic input/output system (BIOS), which controls certain basic functions of processing system 400.

Further depicted are an input/output (I/O) adapter 427 and a network adapter 426 coupled to system bus 433. I/O adapter 427 may be a small computer system interface (SCSI) adapter that communicates with a hard disk 435 and/or a storage device 436 or any other similar component. I/O adapter 427, hard disk 435, and storage device 436 are collectively referred to herein as mass storage 434. Operating system 440 for execution on processing system 400 may be stored in mass storage 434. The network adapter 426 interconnects system bus 433 with an outside network 438 enabling processing system 400 to communicate with other such systems.

A display (e.g., a display monitor) 439 is connected to system bus 433 by display adapter 432, which may include a graphics adapter to improve the performance of graphics intensive applications and a video controller. In one aspect of the present disclosure, adapters 426, 427, and/or 432 may be connected to one or more I/O buses that are connected to system bus 433 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 433 via user interface adapter 428 and display adapter 432. A keyboard 429, mouse 430, and speaker 431 may be interconnected to system bus 433 via user interface adapter 428, which may include, for example, a Super I/O chip integrating multiple device adapters into a single integrated circuit.

In some aspects of the present disclosure, processing system 400 includes a GPU 437. Graphics processing unit 437 is a specialized electronic circuit designed to manipulate and alter memory to accelerate the creation of images in a frame buffer intended for output to a display. In general, graphics processing unit 437 is very efficient at manipulating computer graphics and image processing and has a highly parallel structure that makes it more effective than general-purpose CPUs for algorithms where processing of large blocks of data is done in parallel.

Thus, as configured herein, processing system 400 includes processing capability in the form of processors 421, storage capability including the system memory 422 and mass storage 434, input means such as keyboard 425 and mouse 430, and output capability including speaker 431 and display 439. In some aspects of the present disclosure, a portion of system memory 422 and mass storage 434 collectively store the operating system 440 to coordinate the functions of the various components shown in processing system 400.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method comprising:
receiving a ride request from a user device associated with a user;
determining suitable vehicles based on the ride request;
collecting and storing vehicle data from the suitable vehicles, the vehicle data indicating thermal information about the suitable vehicles;
generating a thermal ranking of the suitable vehicles based on the vehicle data;
generating a route plan based on the thermal ranking; and
autonomously deploying one of the suitable vehicles based on the thermal ranking and the route plan.

2. The computer-implemented method of claim 1, wherein the vehicle data comprises at least one selected from a group consisting of environmental data, cabin thermal state of health data, rechargeable energy storage system state of health data, thermal system state of health data, compute state of health data, and sensor suite state of health data.

3. The computer-implemented method of claim 1, wherein the vehicle data comprises environmental data, cabin thermal state of health data, rechargeable energy storage system state of health data, thermal system state of health data, compute state of health data, and sensor suite state of health data.

4. The computer-implemented method of claim 1, wherein the one of the suitable vehicles that is deployed is selected based on an overall thermal status rank.

5. The computer-implemented method of claim 4, wherein the overall thermal status rank is determined based on environmental conditions, cabin conditions, rechargeable energy storage system state of health, compute state of health, a thermal system state of health, and forecasts.

6. The computer-implemented method of claim 5, wherein the environmental conditions comprise an initial outside air temperature, a corrected outside air temperature, and a solar load.

7. The computer-implemented method of claim 5, wherein the cabin conditions comprise an initial cabin air temperature, a filtered cabin air temperature, a user desired cabin temperature, and a change in desired cabin temperature relative to a current raw temperature.

8. The computer-implemented method of claim 5, wherein the rechargeable energy storage system state of health comprises a high voltage cooling priority request, a rechargeable energy storage system cell temperature, and a rechargeable energy storage system state of health value.

9. The computer-implemented method of claim 5, wherein the compute state of health comprises an autonomous vehicle cooling priority request, a maximum central processing unit temperature, a maximum graphics processing unit temperature, a maximum motherboard temperature, and a maximum memory temperature.

10. The computer-implemented method of claim 5, wherein the thermal system state of health comprises a chiller power request, an evaporator power request, a cooling power residual capacity, and a chiller power versus evaporator power ratio.

11. The computer-implemented method of claim 5, wherein the forecasts comprise a forecasted time to achieve cabin comfort, a forecasted rechargeable energy storage system idle time remaining, and a forecasted city range.

12. The computer-implemented method of claim 1, wherein autonomously deploying the one of the suitable vehicles comprises causing the one of the suitable vehicles to follow the route plan to a location indicated by the ride request.

13. An autonomous vehicle deployment system comprising:
a user device that generates a ride request;
a plurality of autonomous vehicles; and
a processing system comprising:
a memory comprising computer readable instructions; and
a processing device for executing the computer readable instructions, the computer readable instructions controlling the processing system to perform operations for thermal state-based autonomous vehicle deployment, the operations comprising:
receiving the ride request from the user device associated with a user;
determining suitable vehicles based on the ride request;
collecting and storing vehicle data from the suitable vehicles, the vehicle data indicating thermal information about the suitable vehicles, user data, and user preferences;
generating a thermal ranking of the suitable vehicles based on the vehicle data;
generating a route plan based on the thermal ranking; and
autonomously deploying one of the suitable vehicles based on the thermal ranking and the route plan.

14. The autonomous vehicle deployment system of claim 13, wherein the vehicle data comprises at least one selected from a group consisting of environmental data, cabin thermal state of health data, rechargeable energy storage system state of health data, thermal system state of health data, compute state of health data, and sensor suite state of health data.

15. The autonomous vehicle deployment system of claim 13, wherein the vehicle data comprises environmental data, cabin thermal state of health data, rechargeable energy storage system state of health data, thermal system state of health data, compute state of health data, and sensor suite state of health data.

16. The autonomous vehicle deployment system of claim 13, wherein the one of the suitable vehicles that is deployed is selected based on an overall thermal status rank.

17. The autonomous vehicle deployment system of claim 16, wherein the overall thermal status rank is determined based on environmental conditions, cabin conditions, rechargeable energy storage system state of health, compute state of health, thermal system state of health, and forecasts.

18. A computer program product comprising:
a set of one or more computer-readable storage media;
program instructions, collectively stored in the set of one or more computer-readable storage media, for causing a processor set to perform computer operations for thermal state-based autonomous vehicle deployment, the computer operations comprising:
receiving a ride request from a user device associated with a user;
determining suitable vehicles based on the ride request;
collecting and storing vehicle data from the suitable vehicles, the vehicle data indicating thermal information about the suitable vehicles;
generating a thermal ranking of the suitable vehicles based on the vehicle data;
generating a route plan based on the thermal ranking; and
autonomously deploying one of the suitable vehicles based on the thermal ranking and the route plan.

19. The computer program product of claim 18, wherein the one of the suitable vehicles that is deployed is selected based on an overall thermal status rank.

20. The computer program product of claim 19, wherein the overall thermal status rank is determined based on environmental conditions, cabin conditions, rechargeable energy storage system state of health, compute state of health, thermal system state of health, and forecasts,
wherein the environmental conditions comprise an initial outside air temperature, a corrected outside air temperature, and a solar load,
wherein the cabin conditions comprise an initial cabin air temperature, a filtered cabin air temperature, a user desired cabin temperature, and a change in desired cabin temperature relative to a current raw temperature,
wherein the rechargeable energy storage system state of health comprises a high voltage cooling priority request, a rechargeable energy storage system cell temperature, and a rechargeable energy storage system state of health value,
wherein the compute state of health comprises an autonomous vehicle cooling priority request, a maximum central processing unit temperature, a maximum graphics processing unit temperature, a maximum motherboard temperature, and a maximum memory temperature,
wherein the thermal system state of health comprises a chiller power request, an evaporator power request, a cooling power residual capacity, and a chiller power versus evaporator power ratio, and
wherein the forecasts comprise a forecasted time to achieve cabin comfort, a forecasted rechargeable energy storage system idle time remaining, and a forecasted city range.
